(19) United States
(12) Patent Application Publication
(10) Pub. No.: US 2007/0234385 A1
(43) Pub. Date: Oct. 4, 2007

(54) Cross-layer video quality manager

(76) Inventors: Rajendra Bopardikar, Phoenix, AZ (US); Bijan Hakimi, Phoenix, AZ (US)

Correspondence Address: KACVINSKY LLC;C/O INTELLEVATE, P.O. BOX 52050, MINNEAPOLIS, MN, 55402, US

(21) Appl. No.: 11/396,101

(22) Filed: Mar. 31, 2006

(51) Int. Cl. H04N 5/445

(52) U.S. Cl. 725/38

(57) ABSTRACT

An embodiment is a cross-layer video quality manager that coordinates a plurality of video processing and network processing techniques to improve the quality of experience of, for example, a streaming video.

### BACKGROUND

The latest international video coding standard is the H.264/MPEG-4 Advanced Video Coding (AVC) standard jointly developed and promulgated by the Video Coding Experts Group of the International Telecommunications Union (ITU) and the Motion Picture Experts Group (MPEG) of the International Organization for Standardization and the International Electrotechnical Commission. The AVC H.264/MPEG-4 AVC standard provides coding for a wide variety of applications including video telephony, video conferencing, television, streaming video, digital video authoring, and other video applications. The standard further provides coding for storage applications for the above noted video applications including hard disk and DVD storage.

The popularization of the “digital home” has increased the demand for home network performance as increasing numbers of components or processes interact with the home network environment in a wired or wireless fashion. However, the resources available to support the digital home are finite. Accordingly, the finite resources (e.g., bandwidth) should be efficiently allocated among the constituent components or processes to provide, for example, an end-user a high quality of digital home experience.

### BRIEF DESCRIPTION OF THE DRAWINGS

FIG. 1 illustrates an embodiment of a media processing system.

FIG. 2 illustrates an embodiment of a media processing sub-system.

FIG. 3 illustrates an initialization logic flow of an embodiment.

FIG. 4 illustrates an admission decision logic flow of an embodiment.

FIG. 5 illustrates a run-time logic flow of an embodiment.

FIG. 6 illustrates s block diagram of a cross-layer video quality manager of an embodiment.

FIG. 7 illustrates a logic flow of an embodiment.

### DETAILED DESCRIPTION

Techniques for cross-layer video quality management will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Various embodiments are directed to a cross-layer video quality manager (CL-VQM) that coordinates a plurality of video processing and network processing techniques to improve the quality of experience of, for example, a video for an end-user. For example, the CL-VQM may monitor and control a network and adjust the video processing according to the network conditions. Further, the application of the CL-VQM across network layers (e.g., layers according to the OSI seven layer model) allows the CL-VQM to control the network by coordinating a variety of layer-specific techniques to improve the quality of experience for the end-user.

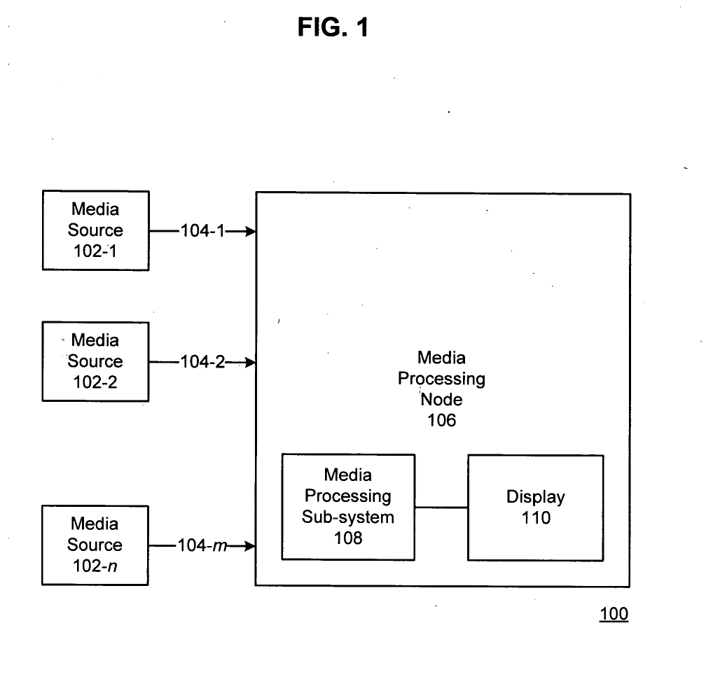

FIG. 1 illustrates one embodiment of a system. FIG. 1 illustrates a block diagram of a system 100. In one embodiment, for example, system 100 may comprise a media processing system having multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, the communications system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television System Committee (NTSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of system 100 may be arranged to communicate, manage or process different types of information, such as media information and control information. Examples of media information may generally include any data representing content meant for a user, such as voice information, video information, audio information, image information, textual information, numerical information, alphanumeric symbols, graphics, and so forth. Control information may refer to any data representing commands, instructions or control words meant for an automated system. For example, control information may be used to route media information through a system, to establish a connection between devices, instruct a node to process the media information in a predetermined manner, and so forth. The embodiments are not limited in this context.

In various embodiments, system 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media. An example of wireless communication media may include portions of a wireless spectrum, such as the RF spectrum in general, and the ultra-high frequency (UHF) spectrum in particular. The wireless nodes may include components and interfaces suitable for communicating information signals over the designated wireless spectrum, such as one or more antennas, wireless transmitters/receivers (“transceivers”), amplifiers, filters, control logic, antennas, and so forth. The embodiments are not limited in this context.

In various embodiments, system 100 may comprise a media processing system having one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a Digital Versatile Disk (DVD) device, a Video Home System (VHS) device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720p), which refers to 720 vertical pixels and 1280 horizontal pixels (720×1280). In another example, the media information may have a visual resolution format corresponding to various computer display formats, such as a video graphics array (VGA) format resolution (640×480), an extended graphics array (XGA) format resolution (1024×768), a super XGA (SXGA) format resolution (1280×1024), an ultra XGA (UXGA) format resolution (1600×1200), and so forth. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (CODEC), a filtering device (e.g., graphic scaling device, deblocking filtering device), a transformation device, an entertainment system, a display, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to manage neighboring block data of, for example, a JSVC/H.264 video decoder for an image or picture and perform other media processing operations as described in more detail below. Media processing sub-system 108 may output the processed media information to a display 110. The embodiments are not limited in this context.

In various embodiments, media processing node 106 may include a display 110. Display 110 may be any display capable of displaying media information received from media source nodes 102-1-n. Display 110 may display the media information at a given format resolution. For example, display 110 may display the media information on a display having a VGA format resolution, XGA format resolution, SXGA format resolution, UXGA format resolution, and so forth. The type of displays and format resolutions may vary in accordance with a given set of design or performance constraints, and the embodiments are not limited in this context.

In general operation, media processing node 106 may receive media information from one or more of media source nodes 102-1-n. For example, media processing node 106 may receive media information from a media source node 102-1 implemented as a DVD player integrated with media processing node 106. Media processing sub-system 108 may retrieve the media information from the DVD player, convert the media information from the visual resolution format to the display resolution format of display 110, and reproduce the media information using display 110.

In various embodiments, media processing node 106 may be arranged to receive an input image from one or more of media source nodes 102-1-n. The input image may comprise any data or media information derived from or associated with one or more video images. In various embodiments, the input image may comprise one or more of image data, video data, video sequences, groups of pictures, pictures, images, regions, objects, frames, slices, macroblocks, blocks, pixels, signals, and so forth. The values assigned to pixels may comprise real numbers and/or integer numbers.

In various embodiments, media processing node 106 may be arranged to coordinate a plurality of video processing and network processing techniques to improve the quality of experience of, for example, a the presentation of the media (e.g., a video) to an end-user. For example, the media processing node 106 may monitor and control a network and adjust the video processing according to the network conditions. Further, the media processing node 106 may control the network by coordinating a variety of layer-specific techniques to improve the quality of experience for the end-user.

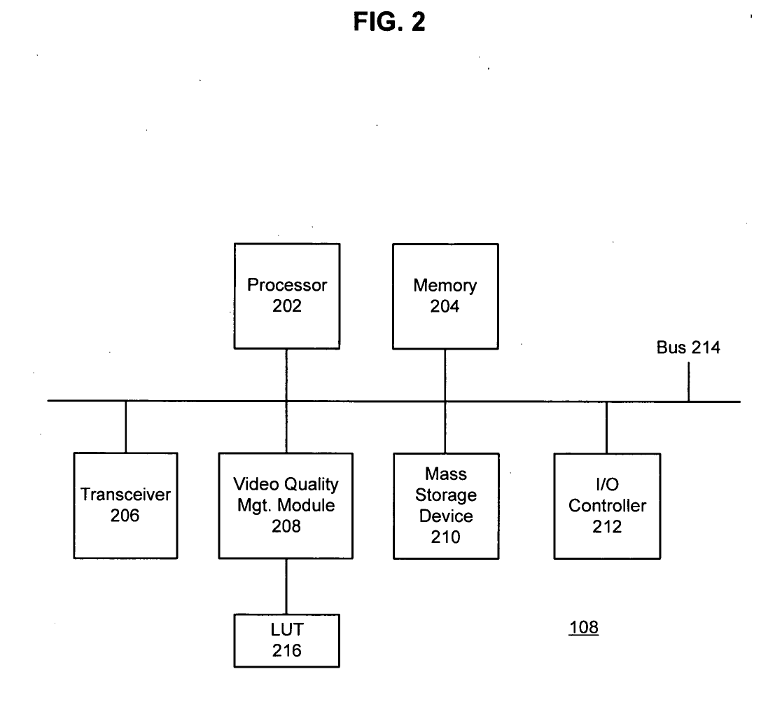

In one embodiment, for example, media processing sub-system 108 of media processing node 106 may be arranged to coordinate a plurality of video processing and network processing techniques. More specifically, the media processing sub-system 108 may be arranged to coordinate and control a plurality of quality of service (QoS) and optimization techniques directed to video processing, network processing, or portions thereof (e.g., network processing directed to individual layer(s) of the network) that otherwise may be independent or independently controlled to improve the overall performance of system 100. Media processing sub-system 108 may utilize one or more pre-defined or predetermined mathematical functions or pre-computed tables to control the processing and output (e.g., to the display 110) of a video to improve system 100 performance, and in particular the quality of experience for a system 100 end-user. System 100 in general, and media processing sub-system 108 in particular, may be described in more detail with reference to FIG. 2.

FIG. 2 illustrates one embodiment of a media processing sub-system 108. FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include a transceiver 206. Transceiver 206 may be any radio transmitter and/or receiver arranged to operate in accordance with a desired wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1×RTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In one embodiment, for example, media processing sub-system 108 may include a video quality management module 208. The video quality management module 208 may be arranged to coordinate and control a plurality of quality of service (QoS) and optimization techniques directed to video processing, network processing, or portions thereof (e.g., network processing directed to individual layer(s) of the network) that otherwise may be independent or independently controlled as introduced above according to predetermined mathematical functions, algorithms, or tables. For example, the predetermined mathematical functions, algorithms, or tables may be stored in any suitable storage device, such as memory 204, a mass storage device (MSD) 210, a hardware-implemented lookup table (LUT) 216, and so forth. It may be appreciated that macroblock module 208 may be implemented as software executed by processor 202, dedicated hardware, or a combination of both. The embodiments are not limited in this context.

In various embodiments, media processing sub-system 108 may include a MSD 210. Examples of MSD 210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

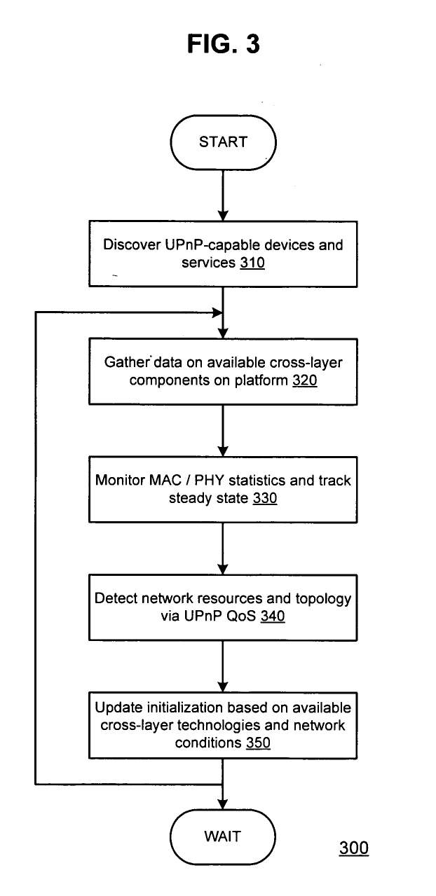

In general operation, media processing sub-system 108 may receive media information from one or more media source nodes 102-1-n. For example, media source node 102-1 may comprise a DVD device connected to processor 202. Alternatively, media source 102-2 may comprise memory 204 storing a digital AV file, such as a motion pictures expert group (MPEG) encoded AV file. The video quality management module 208 may operate to receive the media information from mass storage device 216 and/or memory 204, process the media information (e.g., via processor 202), and store or buffer the media information on memory 204, the cache memory of processor 202, or a combination thereof. The operation of the video quality manager module 208 may be understood with reference to FIG. 3 through FIG. 7.

There currently exist numerous techniques (either standards-based or proprietary) that address QoS and other optimizations to improve the quality of, for example, streaming video. QoS and optimization techniques have been proposed at, for example, various layers in the network layer stack to improve streaming video quality. For example. there are prioritization and parameterization techniques that are defined at the link layer of the network layer stack such as IEEE 802.1D in for Ethernet connections and IEEE 802.11e for wireless connections. In addition, there are upper layer techniques, for example real-time transport protocol (RTP) enhancements that provide QoS processes to manage real-time streaming video traffic. Each QoS and/or optimization technique may provide certain, for example streaming video quality improvements, but no single QoS and/or optimization technique may provide the best video quality under all video or network circumstances.

As introduced, an embodiment coordinates a plurality of video processing and network processing techniques to improve the overall quality of experience of, for example, a streaming video for an end-user. More specifically, an embodiment coordinates various techniques that may each be otherwise independently directed to a particular network layer or layer. Further, an embodiment implementing such a cross-layer coordination may employ the various techniques synchronously and consider each technique's individual advantages and limitations to derive a combination suitable to improve the overall quality of experience for the streaming video. Accordingly, an embodiment may be capable of collecting information from numerous sources across the various layers of the network stack (e.g., MAC statistics, RTP statistics, UPnP QoS statistics, Buffer Fullness Reports from a client, FEC statistics, etc.), and may be able to manipulate one or more technologies directed to the layers as appropriate to maintain video quality in light of, for example, packet loss and bandwidth restrictions.

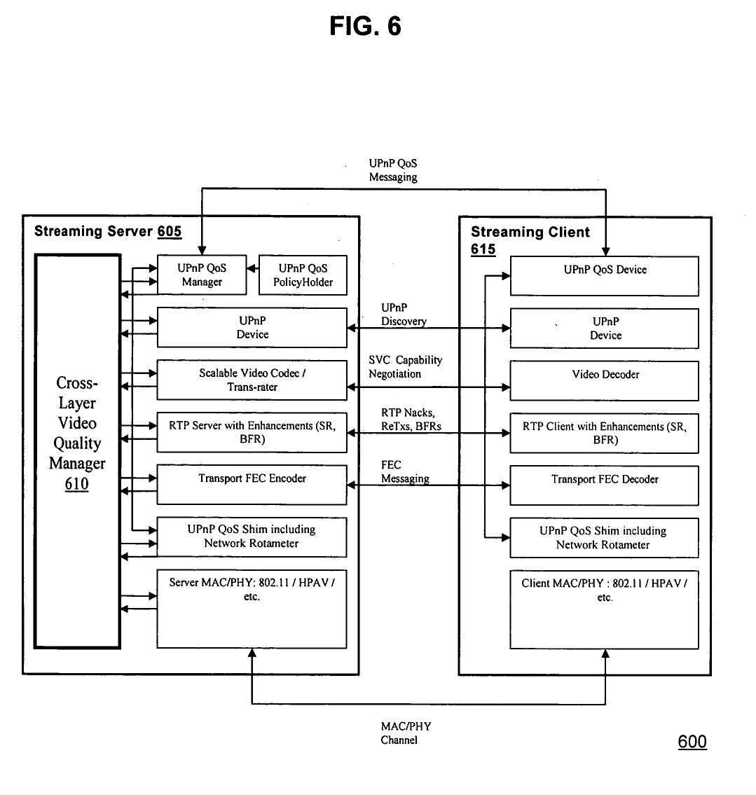

For purposes of discussion (and as illustrated in part by FIG. 6) an embodiment may operate within a network that includes a streaming server and streaming client (or renderer) as part of the network topology. In an embodiment, both the streaming server and the streaming client may reside on, for example, a home or office network, or any network over which streaming video may be processed and/or viewed (e.g., on display 110). Further, the streaming server and streaming client may be connected with one or more links, each of which may include one or more link layer technologies to manage the link. For example, the streaming server may connect via HomePlug AV (HPAV) to a wireless access point that would in turn communicate with the streaming client via, for example, IEEE 802.11g.

Table 1 illustrates details of a sample of existing QoS or other optimization techniques that may be applied to a particular network layer or layers.

TABLE 1

| Technology | Brief Description | Network Layer | Component(s) |
|---|---|---|---|
| UPnP Device | The basic UPnP Device | Application Layer | Device/Service |
| Architecture | architecture allows the | | Discovery; Device/ |
| | discovery and description | | Service Description |
| | of devices and services. | | |
| UPnP QoS | Defines QoS extensions | Messaging at the | QoS Manager; QoS |
| | for UPnP framework. | Application layer; | Device (with |
| | | Enforcement and | rotameter); QoS Policy |
| | | Measurement at | Holder |
| | | Network and Data Link | |
| | | layers | |
| UPnP AV | Defines content | Application Layer | Content Directory |
| | discovery and streaming | | Service; Connection |
| | extensions for UPnP | | Manager; AV |
| | framework | | Transport; Rendering |
| | | | Control |
| Scalable Video | Ability to vary the video | Presentation Layer | Advanced codec |
| Codec/Trans-rater | coding in response to | | capable of trans-rating/ |
| | changing network | | scalable video |
| | conditions | | |
| RTP-over-UDP | RTP transport is best | Transport Layer | RTCP-based Selective |
| Enhancements | suited for real-time video | | Retransmissions, |
| | streaming. Many | | Buffer Fullness |
| | enhancements are | | Reports, etc. |
| | necessary to ensure video | | |
| | quality. | | |
| Transport FEC | Forward Error Correction | Transport Layer | FEC Encoder and |
| | introduces redundancy in | | Decoder |
| | the video stream so that | | |
| | the client can recover | | |
| | from packet loss | | |
| MAC/PHY QoS | Link layer technologies | MAC/PHY Layers | Depends on the type of |
| Functions | such as 802.11e and | | link-layer technology |
| | HPAV provide important | | used. |
| | techniques such as | | |
| | admission control, | | |
| | retransmissions, | | |
| | prioritization, etc. | | |

As noted, an embodiment may simultaneously and dynamically employ one or more of the QoS or other optimization techniques illustrated by Table 1 to improve the overall performance of, for example, system 100. It should be understood that Table 1 merely represents a sample of available QoS or other optimization techniques, and that any QoS or other optimization technique that would benefit, for example, the quality of a streaming video may be coordinated according to an embodiment.

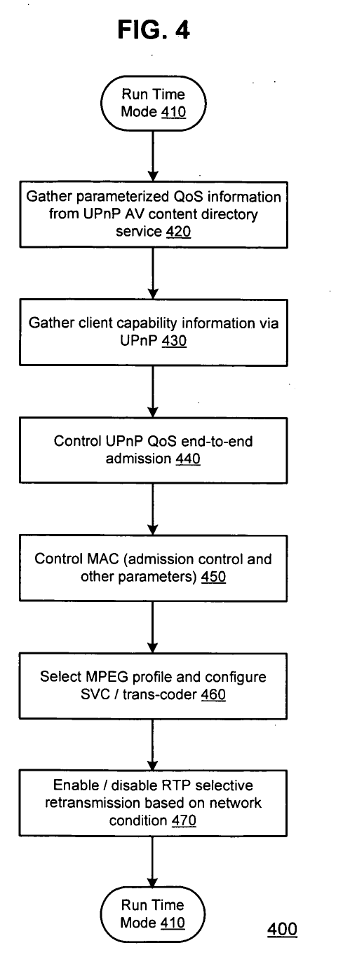

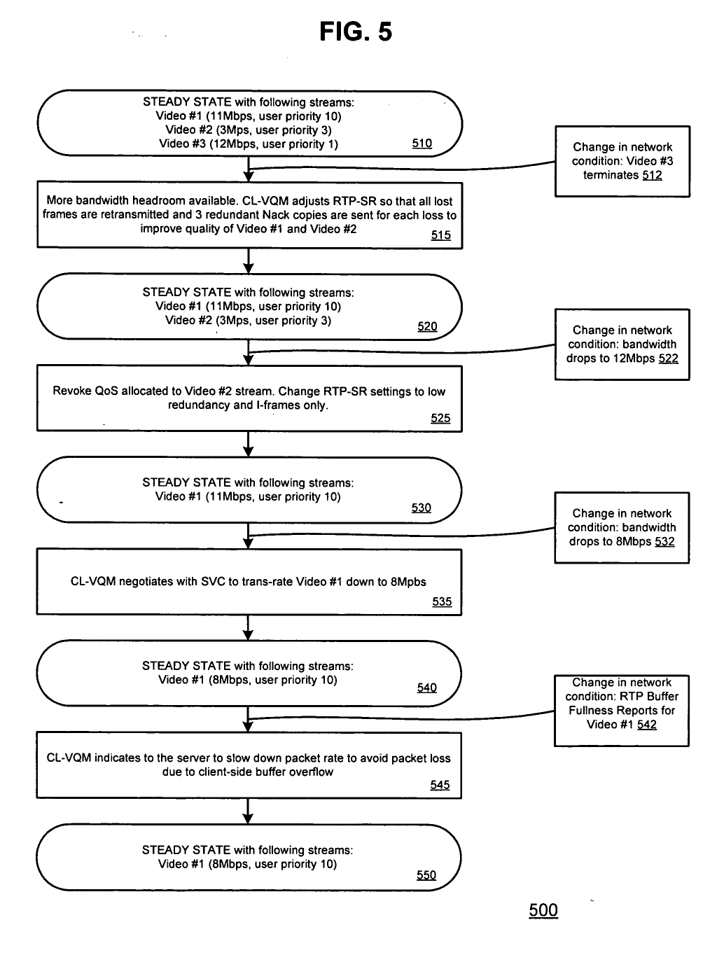

FIG. 3 illustrates a logic flow 300 for initialization according to an embodiment. For example, upon an initialization event (e.g., energizing the system 100 including the video quality management module 208 of an embodiment or connecting the system 100 to a digital home network), at 310 the video quality management module 208 discovers UPnP-capable devices and services. At 320, the video quality management module 208 gathers data on available cross-layer components and technologies that exist on or within the network platform to identify, for example, what QoS or optimization tools may be available. Thereafter, at 330 the video quality management module 208 may monitors MAC and PHY statistics (e.g., available bandwidth, link quality, delay, jitter, number of dropped packets, etc.) in the steady state of the network. At 340, the video quality management module 208 may detect the resources and topology of the network via UPnP QoS processes. At 350, the video quality management module 208 updates the initialization based on the available cross-layer components and technologies gathered at 320 and based on the network conditions monitored and detected at 330 and 340 respectively. Thereafter, following the completion of the initialization process of logic flow 300, run-time algorithms (e.g., illustrated by FIG. 4 and FIG. 5) may begin. It is to be understood that the logic flow 300 initialization process may loop back to 320 if another initialization event occurs.

FIG. 4 illustrates an admission decision logic flow 400 of an embodiment. Run-time mode 410 represents, for example, a steady state during which system 100 including video quality management module 208 may be awaiting a request for a streaming video or processing an existing streaming video. Upon receiving a request for a streaming video, at 420 the video quality management module 208 may gather parameterized Quality of Service (QoS) information from the UPnP AV content directory service. At 430, the video quality management module 208 may gather client capability information via UPnP to determine, for example, if the client has resources available for the streaming video. At 440, the video quality management module 208 may control UPnP QoS end-to-end admission and at 450 controls MAC layer admission control and other parameters to admit the, for example, requested or otherwise incoming streaming video. Based on the properties of the streaming video, the client capability, and network capabilities (e.g., available bandwidth), the video quality management module 208 may select the MPEG profile to use for the streaming video and configure the scalable video codec (SVC)/trans-coder to trans-rate the streaming video (if scalable) to an appropriate bitrate (e.g., in Mbps). Thereafter, at 470, the video quality management module 208 may enable or disable RTP selective retransmission based on the network conditions. The RTP selective retransmission of an embodiment selectively recovers lost packets. The selectivity lies in the fact that RTP packets carrying compressed video (e.g., MPEG2, MPEG4, etc.) may have different levels of importance. For example, the loss of some packets may adversely affect the viewing quality of the video while the loss of other packets may go unnoticed. RTP selective retransmissions includes both RTP and RTCP mechanisms (header extensions, feedback messages, etc.) to help recover from the loss of highly critical lost packets. After coordinating the streaming video admission, the system 100 including the video quality management module 208 may return to run-time mode during which it, for example, processes and displays the admitted streaming video and awaits other streaming videos, the termination of the admitted streaming video, or changing network conditions to which the video quality management module 208 may react.

FIG. 5 illustrates a run-time logic flow 500 of an embodiment that illustrates in detail the operation of the video quality management module 208 of an embodiment as streaming video and network conditions change. For example, the video quality management module 208 may dynamically coordinate among various video and network processes as streaming videos are admitted and terminated as network conditions (e.g., bandwidth) change. For example, at 510 the system 100 in steady state may be processing three videos with bitrates and user priorities as illustrated. At 512, the third video terminates. At 515, with more bandwidth headroom available, the video quality management module may adjust the RTP selective retransmission so that all lost frames are retransmitted and 3 redundant Nack copies are sent for each packet lost to improve the quality of the remaining videos. At 520, the system 100 in steady state processes the remaining two videos. At 522, the available bandwidth of the network drops. In response, the video quality management module 208 at 525 may coordinate the revocation of the QoS allocated to the second streaming video (e.g., the video with the lowest user priority). The video quality management module 208 may further alter the RTP selective retransmission settings to reduce redundancy and process I frames only. Accordingly, at 530 the system 100 in steady state processes only one remaining video. At 532, however, the available network bandwidth drops below what is required to maintain the remaining streaming video at its current bitrate. At 535, the video quality management module 208 negotiates with the SVC to trans-rate the streaming video down to a bitrate that is compatible with the available network bandwidth at which the system 100 remains in steady state at 540. At 542, an RTP Buffer Fullness Report for the remaining video indicates that the client may not have the resources to continue processing the streaming video at its current quality and bitrate. In response, at 545 the video quality management module 208 coordinates a reduction in packet rate at the server to avoid packet loss due to the indicated client buffer overflow. At 550, the system 100 at steady state processes the resulting video.

FIG. 6 illustrates s block diagram of a system 600 including a streaming server 605, cross-layer video quality manager (CL-VQM) 610 of an embodiment, and a streaming client 615. As illustrated, the CL-VQM 610 of an embodiment is included as part of the streaming server 605. Table 2 summarizes various interfaces present in system 600 between the CL-VQM 610 of an embodiment and the streaming server 605. Of note is that the CL-VQM 610 of an embodiment, as illustrated by the bi-directional arrows, may control and coordinate among any of the various modules, components, interfaces, and the like to improve the quality of experience of, for example, a streaming video processed by system 600.

TABLE 2

| Interface | Information flowing to | Information flowing | |
|---|---|---|---|
| Name | CL-VQM | from CL-VQM | Comments |
| UPnP QoS | Rotameter statistics of | UPnP QoS end-to-end | This interface allows the CL-VQM to |
| | client obtained by QoS | admission control - | gather network statistics (via the |
| | Manager. Exchange of | both run-time and | rotameter service). Corrective actions |
| | Traffic Specification | initial. | are possible through the QoS Manager. |
| | (TSpec). | | |
| UPnP AV | Metadata from Content | NA | Metadata about the content is present in |
| | Directory Service; | | the CDS. It may include TSPEC |
| | MPEG profiles supported | | information. Also, UPnP AV allows the |
| | by the client | | client to expose its supported MPEG |
| | | | profiles which can be used in making |
| | | | SVC/trans-rating decisions. |
| UPnP Device | Whether the client | NA | Discovery of client's capabilities. |
| | supports UPnP; Which | | |
| | services does the client | | |
| | support | | |
| Scalable Video | NA | Video quality/bit-rate | Video quality/bit-rate can be |
| Codec (SVC)/ | | | manipulated in response to changing |
| Transrating | | | network conditions. |
| RTP | RTP Selective | Turn Selective | This interface allows the CL-VQM to |
| | Retransmission statistics; | Retransmission | gather RTP statistics (such as receiver |
| | RTP Buffer Fullness | ON/OFF; manipulate | reports) and also allows taking corrective |
| | Reports received from the | selectivity parameters. | actions such as manipulating packet rate |
| | client; | Manipulate outgoing | and selectivity of packet |
| | | packet rate based on | retransmissions. |
| | | client's buffer fullness. | |
| Forward Error | FEC Statistics; FEC | FEC Protection Period | Allows CL-VQM to gather FEC statistics, |
| Correction | feedback from the client | | and manipulation of the protection |
| (FEC) | | | period. |
| QoS Shim | UPnP QoS configuration; | 802.1D priority - | This interface can be used to |
| | stats; | should be altered via | communicate directly with the QoS Shim |
| | | QoS Manager. | Layer to gather statistics, configuration, |
| | | | etc. However, this interface should not |
| | | | be used for manipulation. Need to use |
| | | | QoS Manager instead. |
| Ethernet | 802.3 stats | Manipulate 802.1D | This interface would allow the CL-VQM to |
| MAC/PHY | | priority via QoS | communicate directly with 802.3 adapter |
| | | Manager | to gather stats and manipulate settings. |
| 802.11 | 802.11 stats | 802.1D priority via | This interface would allow the CL-VQM to |
| MAC/PHY | | QoS Manager; | communicate directly with 802.11 |
| | | admission control; | adapter to gather stats and manipulate |
| | | number of retries; | settings. |
| HPAV | HPAV stats | 802.1D priority via | This interface would allow the CL-VQM to |
| MAC/PHY | | QoS Manager; | communicate directly with HPAV adapter |
| | | admission control; | to gather stats and manipulate settings. |
| | | number of retries; | |

It is to be understood that while FIG. 6 and Table 2 summarize numerous blocks and interfaces that the CL-VQM 610 of an embodiment is not limited thereto. Rather, the CL-VQM may coordinate and control any graphics or network process that may improve the quality of experience for a, for example, streaming video processed by system 600.

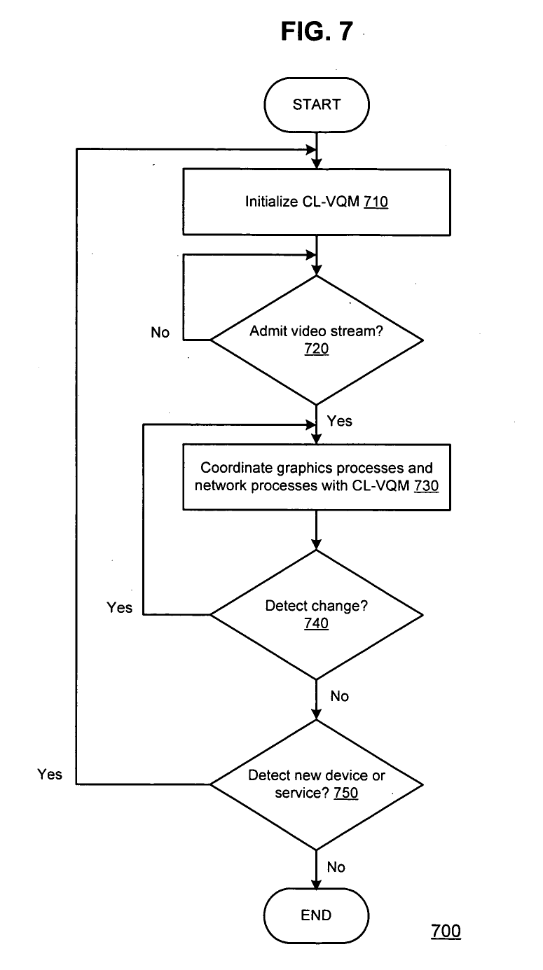

FIG. 7 illustrates a flow chart of an embodiment. At 710, the CL-VQM may be initialized, for example upon an initialization event (e.g., energizing the system 100 including the CL-VQM of an embodiment or connecting the system 100 to a digital home network) according to the initialization logic flow 300 of FIG. 3. Thereafter, at 720 the CL-VQM determines whether or not to admit a new video stream having received a request according to, for example, the admission decision logic flow 400 of FIG. 4. If there is no request for a new streaming video or if the CL-VQM does not admit a video stream, the CL-VQM waits until it receives another request for a streaming video. If the CL-VQM admits the video, at 730 the CL-VQM coordinates graphics processes and cross-layer network processes as detailed above to improve the quality (e.g., quality of experience) of the streaming video. Thereafter, at 740 if the CL-VQM detects a change (e.g., change in bandwidth, termination of a video stream, client buffer fullness, etc., as detailed above with reference to FIG. 5), it will re-coordinate the graphics processes and cross-layer network processes. At 750, if the CL-VQM detects a new device or service (e.g., via UPnP discovery), the logic flow 700 will loop back to the initialization at 710 to update.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will occur to those skilled in the art. It is therefore to be understood that the appended claims are intended to cover all such modifications and changes as fall within the true spirit of the embodiments.

What is claimed is:

1. An apparatus comprising:
a media processing node to coordinate among a plurality of graphic processes and a plurality of cross-layer network processes to improve the quality of a streaming video.

2. The apparatus of claim 1, the media processing node to include a video quality management module, the video quality management module to further:
admit a video stream depending on a network condition.

3. The apparatus of claim 2, the video quality management module to further:
detect a change in the network condition.

4. The apparatus of claim 3, the video quality management module to further:
re-coordinate at least a graphics process or a network process in response to the change in network condition.

5. The apparatus of claim 4 wherein at least one network process is directed to a different network layer than another network process.

6. A system comprising:
a wired communications medium; and
a media processing node coupled to the communications medium to coordinate among a plurality of graphic processes and a plurality of cross-layer network processes to improve the quality of a streaming video.

7. The system of claim 6, the media processing node to include a video quality management module, the video quality management module to further:
admit a video stream depending on a network condition.

8. The system of claim 7, the video quality management module to further:
detect a change in the network condition.

9. The system of claim 8, the video quality management module to further:
re-coordinate at least a graphics process or a network process in response to the change in network condition.

10. The system of claim 9 wherein at least one network process is directed to a different network layer than another network process.

11. A method comprising:
initializing a video quality management module;
admitting, by the video quality management module, a video stream; and
coordinating, by the video quality management module, a plurality of graphics processes and a plurality of network processes to improve the quality of the video stream.

12. The method of claim 11, initializing the video quality management module further comprising:
discovering a UPnP device or service;
monitoring a network condition; and
detecting a cross-layer component.

13. The method of claim 11, admitting the video stream further comprising:
gathering network QoS and client capability information;
selecting an MPEG profile;
configuring a scalable video decoder; and
controlling an RTP selective retransmission.

14. The method of claim 11, wherein at least one network process is directed to a different network layer than another network process.

15. The method of claim 14 further comprising:
detecting a change in a network condition; and
re-coordinating, by the video quality management module, at least a graphics process or a network process.

16. An article comprising a machine-readable storage medium containing instructions that if executed enable a system to:
initialize a video quality management module;
admit, by the video quality management module, a video stream; and
coordinate, by the video quality management module, a plurality of graphics processes and a plurality of network processes to improve the quality of the video stream.

17. The article of claim 16 further comprising instructions that if executed enable the system to:
discover a UPnP device or service;
monitor a network condition; and
detect a cross-layer component.

18. The article of claim 17, further comprising instructions that if executed enable the system to:
gather network QoS and client capability information;
select an MPEG profile;
configure a scalable video decoder; and
control an RTP selective retransmission.

19. The article of claim 18 wherein at least one network process is directed to a different network layer than another network process.

20. The article of claim 19, further comprising instructions that if executed enable the system to:
detect a change in a network condition; and
re-coordinate, by the video quality management module, at least a graphics process or a network process.
